(19) United States
(12) Patent Application Publication
(10) Pub. No.: US 2026/0135383 A1
(43) Pub. Date: May 14, 2026

(54) PHOTOVOLTAIC-STORAGE SELF-ADAPTIVE VIRTUAL OSCILLATOR GRID-FORMING CONTROL METHOD COMPATIBLE WITH MAXIMUM POWER POINT TRACKING, APPARATUS, AND STORAGE MEDIUM

(71) Applicant: TSINGHUA UNIVERSITY, Beijing (CN)

(72) Inventors: Wenchuan WU, Beijing (CN); Zizhen GUO, Beijing (CN); Hongbin SUN, Beijing (CN); Haotian LIU, Beijing (CN)

(21) Appl. No.: 19/354,869

(22) Filed: Oct. 10, 2025

(30) Foreign Application Priority Data
Nov. 13, 2024 (CN) 202411620553.7

(51) Int. Cl. H02J 3/24; G05B 13/04

(52) U.S. Cl. CPC H02J 3/0014; G05B 13/042

(57) ABSTRACT

Provided are a photovoltaic-storage self-adaptive virtual oscillator grid-forming control method compatible with maximum power point tracking, an apparatus, and a storage medium. The method includes: obtaining a present voltage instruction for an inverter, and an output current, an output voltage and an output power of a direct current source, and determining a target active power based on the output power of the direct current source, a power operation set value, and the output voltage of the direct current source; oscillating the present voltage instruction by using a full-state virtual oscillator based on the target active power, a present output current of the inverter, and an oscillation set value to generate a target voltage instruction; and sending the target voltage instruction to the inverter, to enable the inverter to output a first target voltage signal based on the target voltage instruction.

### CROSS-REFERENCE TO RELATED APPLICATION

This application claims priority to and benefits of Chinese patent applications No. 202411620553.7 filed with China National Intellectual Property Administration on Nov. 13, 2024, the entire content of which is incorporated herein by reference.

### FIELD

The present disclosure relates to the field of grid-forming control technologies, and more particularly, to a photovoltaic-storage self-adaptive virtual oscillator grid-forming control method compatible with maximum power point tracking, an apparatus, and a storage medium.

### BACKGROUND

Grid-forming control technology is a voltage-source control strategy. Conventional grid-forming control restricts a photovoltaic-storage system to only track an alternating current voltage signal from a power grid to provide synchronized current injection. Under weak grid conditions, poor synchronization characteristics of grid-forming control may limit a grid connection and power delivery capability of new energy sources, and may lead to more severe frequency and voltage fluctuations in a regional power grid, making it difficult to ensure operational stability and economic efficiency of a new power system characterized by high penetration of new energy sources.

### SUMMARY

To solve the above problems, the present disclosure is provided, which, through specific embodiments, provides a photovoltaic-storage self-adaptive virtual oscillator grid-forming control method compatible with maximum power point tracking, an apparatus, and a storage medium.

In a first aspect, embodiments of the present disclosure provide a photovoltaic-storage self-adaptive virtual oscillator grid-forming control method compatible with maximum power point tracking. The method includes: obtaining a present voltage instruction for an inverter, an output current of a direct current source, an output voltage of the direct current source, and an output power of the direct current source, and determining a target active power based on the output power of the direct current source, a power operation set value, and the output voltage of the direct current source; oscillating the present voltage instruction for the inverter by using a full-state virtual oscillator based on the target active power, a present output current of the inverter, and an oscillation set value to generate a target voltage instruction for the inverter; and sending the target voltage instruction for the inverter to the inverter, to enable the inverter to output a first target voltage signal based on the target voltage instruction for the inverter.

Further, the determining the target active power based on the output power of the direct current source, the power operation set value, and the output voltage of the direct current source includes: determining the power operation set value as the target active power when the output power of the direct current source is greater than the power operation set value; and determining a maximum power point of the direct current source as the target active power when the output power of the direct current source is smaller than or equal to the power operation set value.

Further, the determining the target active power based on the output power of the direct current source, the power operation set value, and the output voltage of the direct current source includes: determining the target active power by using a pre-established power self-adaptive model based on the output power of the direct current source, the power operation set value, and the output voltage of the direct current source. An expression of the power self-adaptive model is:

$${p}^{*} = \{ \begin{matrix}\int {K}_{i} ( {p}_{dc} - {p}_{set} ) , & {p}_{dc} > {p}_{set} \\ \int {K}_{i} \frac{\partial {p}_{dc}}{\partial {v}_{dc}} , & {p}_{dc} ⩽ {p}_{set}\end{matrix} ,$$

Where p* is the target active power, p_{dc} is the output power of the direct current source, pₛₑₜ is the power operation set value, υ_{dc} is the output voltage of the direct current source, an operator of ∫ is an integral operation, an operator of ∂ is a differential operation, T_{d} is a differential filtering time constant, and Kᵢ is a self-adaptive power regulation control parameter.

Further, expressions of the full-state virtual oscillator are:

$$\frac{d}{dt} {v}_{o} = {ω}_{o} {Jv}_{o} + η ( {Kv}_{o} - R ( κ ) {i}_{o} + μϕ ( {v}_{m} , {v}_{dc} ) {v}_{o} ) ,$$

$$K = \frac{1}{{v}_{m}^{* 2}} R ( κ ) [ \begin{matrix}{p}^{*} & {q}^{*} \\ - {q}^{*} & {p}^{*}\end{matrix} ] ,$$

$${ω}_{o} = {ω}_{n} + λ \cdot sin ( κ ) ( {v}_{dc} - {v}_{dc}^{*} ) ,$$

$$ϕ ( {v}_{m} , {v}_{dc} ) = \frac{{v}_{m}^{*} - {v}_{m}}{{v}_{m}^{*}} + \frac{λ}{ημ} cos κ ( {v}_{dc} - {v}_{dc}^{*} ) ,$$

where η is an active synchronization control parameter, μ is an amplitude control parameter, λ is a direct current voltage control parameter, υₘ=∥υₒ∥ is an alternating current voltage amplitude,

$${p}^{*} , {q}^{*} , {v}_{dc}^{*} , {v}_{m}^{*}$$

are the target active power, a reactive power, a direct current voltage amplitude set value, and an alternating current voltage amplitude set value, respectively, ωₙ is a rated frequency of a power grid, [symbol] is a line impedance parameter angle, K is a power setting matrix, ωₒ is a rated frequency, φ(υₘ, υ_{dc}) is a voltage amplitude error function, and
[symbol] is defined as:

$$κ = {tan}^{- 1} ( {ω}_{n} {L}_{g} / {R}_{g} )$$

where L_{g} is a grid-connected line inductance, R_{g} is a grid-connected line resistance; a matrix of R is a two-dimensional rotation matrix, which is defined as:

$$R ( θ ) = [ \begin{matrix}cos θ & - sin θ \\ sin θ & cos θ\end{matrix} ] ,$$

where θ is a matrix rotation angle;
J is defined as:

$$J = R ( π / 2 ) .$$

Further, the method further includes: obtaining a grid-side voltage, a d-axis component and a q-axis component of the output current of the inverter, and an α-axis component and a β-axis component of the output voltage for the inverter; determining an oscillator phase angle based on the α-axis component and the β-axis component of the target voltage instruction for the inverter; determining a current inner-loop control instruction based on the grid-side voltage and the target voltage instruction for the inverter; performing amplitude limiting processing on the current inner-loop control instruction based on a current clamping threshold to obtain a target current inner-loop control instruction; determining a d-axis component and a q-axis component of an output voltage of the inverter based on the target current inner-loop control instruction, the oscillator phase angle, and a d-axis component and a q-axis component of the grid-side voltage; generating a pulse width modulation signal based on the d-axis component and the q-axis component of the output voltage of the inverter and the oscillator phase angle; and transmitting the pulse width modulation signal to the inverter, to enable the inverter to output a second target voltage signal based on the pulse width modulation signal.

Further, the generating the pulse width modulation signal based on the d-axis component and the q-axis component of the output voltage of the inverter and the oscillator phase angle includes: determining a d-axis current error based on a d-axis component of the target current inner-loop control instruction and a d-axis component of the output current of the inverter, and determining the d-axis component of the output voltage of the inverter based on the determined d-axis current error, the d-axis component of the grid-side voltage, a feedforward control gain, and the q-axis component of the output current of the inverter; determining a q-axis current error based on a q-axis component of the target current inner-loop control instruction and the q-axis component of the output current of the inverter, and determining the q-axis component of the output voltage of the inverter based on the determined q-axis current error, the q-axis component of the grid-side voltage, the feedforward control gain, and the d-axis component of the output current of the inverter; and performing coordinate transformation on the d-axis component and the q-axis component of the output voltage of the inverter using the oscillator phase angle to generate the pulse width modulation signal.

Further, an expression of the coordinate transformation is:

$$[ \begin{matrix}{X}_{α} \\ {X}_{β}\end{matrix} ] = \sqrt{\frac{2}{3}} [ \begin{matrix}1 & - \frac{1}{2} & - \frac{1}{2} \\ 0 & \frac{\sqrt{3}}{2} & - \frac{\sqrt{3}}{2}\end{matrix} ] [ \begin{matrix}{x}_{a} \\ {x}_{b} \\ {x}_{c}\end{matrix} ] ,$$

$$[ \begin{matrix}{x}_{d} \\ {x}_{q}\end{matrix} ] = [ \begin{matrix}cos ( θ ) & sin ( θ ) \\ - sin ( θ ) & cos ( θ )\end{matrix} ] [ \begin{matrix}{x}_{α} \\ {x}_{β}\end{matrix} ] ,$$

where x denotes a voltage variable or a current variable, subscripts α, β, d, and q represent an α-axis component, a β-axis component, a d-axis component, and a q-axis component of the denoted variable, respectively, and θ is the oscillator phase angle.

In a second aspect, the embodiments of the present disclosure provide a full-state virtual oscillator grid-forming control apparatus. The apparatus includes: a power self-adaptive module configured to obtain a present voltage instruction for an inverter, an output current of a direct current source, an output voltage of the direct current source, and an output power of the direct current source, and determine a target active power based on the output power of the direct current source, a power operation set value, and the output voltage of the direct current source; a full-state oscillation module configured to oscillate the present voltage instruction for the inverter by using a full-state virtual oscillator based on the target active power, a present output current of the inverter, and an oscillation set value to generate a target voltage instruction for the inverter; and a control module configured to send the target voltage instruction for the inverter to the inverter, to enable the inverter to output a first target voltage signal based on the target voltage instruction for the inverter.

In a third aspect, the embodiments of the present disclosure provide an electronic device. The electronic device includes: a memory; a processor; and a computer program stored in the memory and executable on the processor. The processor is configured to, when executing the computer program, implement the photovoltaic-storage self-adaptive virtual oscillator grid-forming control method compatible with maximum power point tracking according to the above.

In a fourth aspect, the embodiments of the present disclosure provide a computer storage medium having a computer-executable instruction stored therein. The computer storage medium is configured to, when the computer-executable instruction is executed, implement the photovoltaic-storage self-adaptive virtual oscillator grid-forming control method compatible with maximum power point tracking according to the above.

The technical solutions according to the embodiments of the present disclosure may at least provide the following advantageous effects.

The present voltage instruction for the inverter, the output current of the direct current source, the output voltage of the direct current source, and the output power of the direct current source are obtained. The target active power is determined based on the output power of the direct current source, the power operation set value, and the output voltage of the direct current source. Based on the target active power, the present output current of the inverter, and the oscillation set value, the present voltage instruction for the inverter is oscillated by using the full-state virtual oscillator to generate the target voltage instruction for the inverter. The target voltage instruction for the inverter is sent to the inverter, to enable the inverter to output the first target voltage signal based on the target voltage instruction for the inverter. In this way, stable control for a direct current voltage can be realized, avoiding instability of a direct current bus voltage caused by insufficient power delivery capability on a direct current side, and reducing a risk of a collapse in a photovoltaic-storage power generation system.

Other features and advantages of the present disclosure will be described in the following specification, or will become apparent from practice of the present disclosure. Objectives and advantages of the present disclosure can be realized and obtained by means of structures particularly pointed out in the written specification, claims, and accompanying drawings.

The technical solutions of the present disclosure will be described in further detail below with reference to the accompanying drawings and the embodiments.

### BRIEF DESCRIPTION OF THE DRAWINGS

The accompanying drawings are intended to provide a further understanding of the present disclosure and constitute a part of this specification. The accompanying drawings are used together with the embodiments of the present disclosure to explain the present disclosure without constituting any limitation to the present disclosure.

FIG. 1 is a flowchart of a method according to an embodiment of the present disclosure.

FIG. 2 is a grid-forming control block diagram of a method according to an embodiment of the present disclosure.

FIG. 3 is a current inner-loop control block diagram of a method according to an embodiment of the present disclosure.

FIG. 4 is a schematic structural diagram of an electronic device according to an embodiment of the present disclosure.

### DETAILED DESCRIPTION

Exemplary embodiments of the present disclosure will be described in greater detail below with reference to accompanying drawings. Although the accompanying drawings illustrate the exemplary embodiments of the present disclosure, it should be understood that the present disclosure may be implemented in various forms and should not be limited by the embodiments described herein. Rather, these embodiments are provided so that the present disclosure can be understood more thoroughly, and a scope of the present disclosure can be fully conveyed to those skilled in the art.

To solve the problems existing in the related art, the embodiments of the present disclosure provide a photovoltaic-storage self-adaptive virtual oscillator grid-forming control method compatible with maximum power point tracking, an apparatus, an electronic device, and a storage medium.

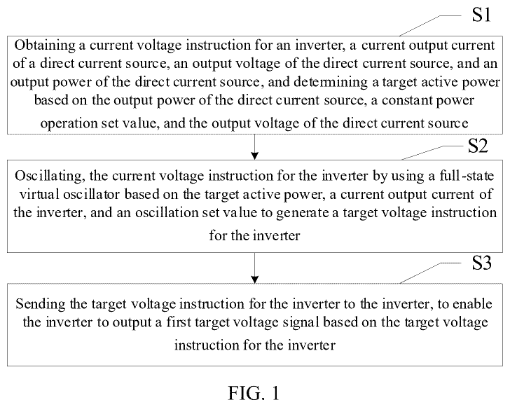

An embodiment of the present disclosure provides a full-state virtual oscillator grid-forming control method, a flow of which is shown in FIG. 1. The method includes operations at blocks.

At S1, a present voltage instruction for an inverter, an output current of a direct current source, an output voltage of the direct current source, and an output power of the direct current source are obtained. A target active power is determined based on the output power of the direct current source, a power operation set value, and the output voltage of the direct current source.

The direct current source is a photovoltaic array or an energy storage battery. The output current of the direct current source is an output current of the photovoltaic array or the energy storage battery. The output voltage of the direct current source is an output voltage of the photovoltaic array or the energy storage battery. The output power of the direct current source is an output power of the photovoltaic array or the energy storage battery. The power operation set value is a power operation set value of a full-state virtual oscillator.

At S2, based on the target active power, a present output current of the inverter, and an oscillation set value, the present voltage instruction for the inverter is oscillated by using a full-state virtual oscillator to generate a target voltage instruction for the inverter.

The oscillation set value includes an alternating current voltage amplitude set value, a direct current voltage amplitude set value, and a rated frequency of a power grid. Oscillating the present voltage instruction for the inverter using the full-state virtual oscillator includes: oscillating a phase, an amplitude, and a frequency of the present voltage instruction for the inverter using the full-state virtual oscillator, determining an oscillation amplitude and an oscillation frequency to generate the target voltage instruction for the inverter.

At S3, the target voltage instruction for the inverter is sent to the inverter, to enable the inverter to output a first target voltage signal based on the target voltage instruction for the inverter.

With the above method according to the present embodiment, the present voltage instruction for the inverter, the output current of the direct current source, the output voltage of the direct current source, and the output power of the direct current source are obtained. The target active power is determined based on the output power of the direct current source, the power operation set value, and the output voltage of the direct current source. Based on the target active power, the present output current of the inverter, and the oscillation set value, the present voltage instruction for the inverter is oscillated by using the full-state virtual oscillator to generate the target voltage instruction for the inverter. The target voltage instruction for the inverter is sent to the inverter, to enable the inverter to output the first target voltage signal based on the target voltage instruction for the inverter. In this way, stable control for a direct current voltage is realized, avoiding instability of a direct current bus voltage caused by an insufficient power delivery capability on a direct current side, and reducing a risk of a collapse in a photovoltaic-storage power generation system. In addition, the oscillator-based control strategy design endows the multi-inverter alternating current grid-connected characteristics with good global asymptotic synchronization stability. It should be noted that with the full-state virtual oscillator design, the photovoltaic-storage power generation system can possess a stable and controllable active support capability under large disturbances on an alternating current side and the direct current side, and preventing inverter islanding caused by energy imbalance in a single unit during the large disturbances.

In the above method according to the present embodiment, the determining the target active power based on the output power of the direct current source, the power operation set value, and the output voltage of the direct current source includes: determining the power operation set value as the target active power when the output power of the direct current source is greater than the power operation set value; and determining a maximum power point of the direct current source as the target active power when the output power of the direct current source is smaller than or equal to the power operation set value.

When the active power is greater than the power operation set value, constant power operation is achieved by reducing the target active power. When the active power is smaller than the power operation set value, maximum power point tracking is automatically performed through a maximum power point tracking algorithm.

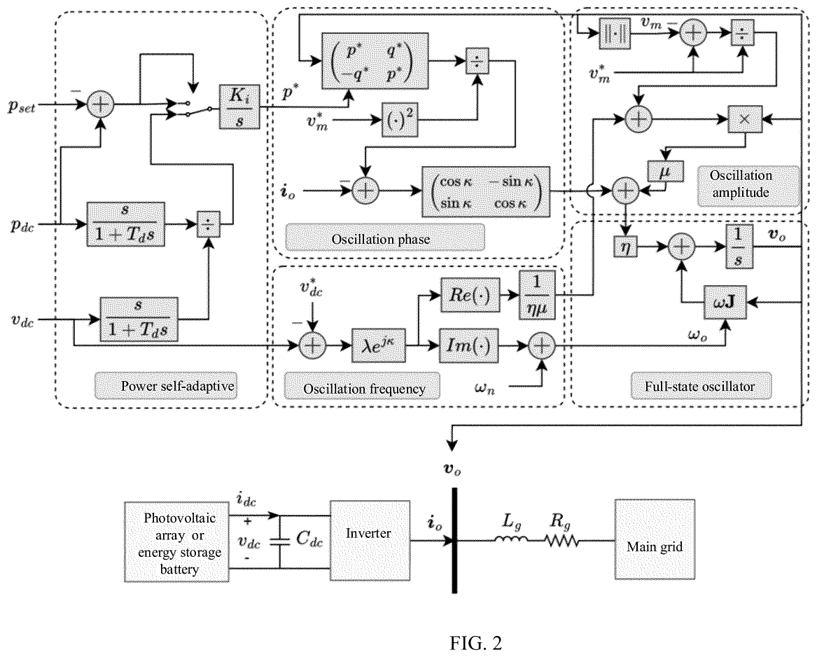

In the above method according to the present embodiment, the determining the target active power based on the output power of the direct current source, the power operation set value, and the output voltage of the direct current source includes: determining the target active power by using a pre-established power self-adaptive model based on the output power of the direct current source, the power operation set value, and the output voltage of the direct current source. An expression of the power self-adaptive model is:

$${p}^{*} = \{ \begin{matrix}\int {K}_{i} ( {p}_{dc} - {p}_{set} ) , & {p}_{dc} > {p}_{set} \\ \int {K}_{i} \frac{\partial {p}_{dc}}{\partial {v}_{dc}} , & {p}_{dc} ⩽ {p}_{set}\end{matrix} ,$$

Where p* is the target active power, p_{dc} is the output power of the direct current source, pₛₑₜ is the power operation set value, υ_{dc} is the output voltage of the direct current source, an operator of ∫ is an integral operation which corresponds to a transfer function 1/s in FIG. 2, an operator of ∂ is a differential operation which corresponds to

$$\frac{s}{1 + {T}_{d} s}$$

in FIG. 2, T_{d} is a differential filtering time constant, and Kᵢ is a self-adaptive power regulation control parameter.

In the above method according to the present embodiment, as illustrated in the grid-forming control block diagram in FIG. 2, expressions of the full-state virtual oscillator are:

$$\frac{d}{dt} {v}_{o} = {ω}_{o} {Jv}_{o} + η ( {Kv}_{o} - R ( κ ) {i}_{o} + μϕ ( {v}_{m} , {v}_{dc} ) {v}_{o} ) ,$$

$$K = \frac{1}{{v}_{m}^{* 2}} R ( κ ) [ \begin{matrix}{p}^{*} & {q}^{*} \\ - {q}^{*} & {p}^{*}\end{matrix} ] ,$$

$${ω}_{o} = {ω}_{n} + λ \cdot sin ( κ ) ( {v}_{dc} - {v}_{dc}^{*} ) ,$$

$$ϕ ( {v}_{m} , {v}_{dc} ) = \frac{{v}_{m}^{*} - {v}_{m}}{{v}_{m}^{*}} + \frac{λ}{ημ} cos κ ( {v}_{dc} - {v}_{dc}^{*} )$$

where η is an active synchronization control parameter, μ is an amplitude control parameter, λ is a direct current voltage control parameter, υₘ=∥υₒ∥ is an alternating current voltage amplitude,

$${p}^{*} , {q}^{*} , {υ}_{d c}^{*} , {υ}_{m}^{*}$$

are the target active power, a reactive power, a direct current voltage amplitude set value, and an alternating current voltage amplitude set value, respectively, ωₙ is a rated frequency of a power grid, [symbol] is a line impedance parameter angle, K is a power setting matrix, ωₒ is a rated frequency, φ(υₘ, υ_{dc}) is a voltage amplitude error function, and
[symbol] is defined as:

$$κ = {tan}^{- 1} ( {ω}_{n} {L}_{g} / {R}_{g} )$$

where L_{g} is a grid-connected line inductance, R_{g} is a grid-connected line resistance; a matrix of R is a two-dimensional rotation matrix, which is defined as:

$$R ( θ ) = [ \begin{matrix}cos θ & - sin θ \\ sin θ & cos θ\end{matrix} ] ,$$

where θ is a matrix rotation angle;
J is defined as:

$$J = R ( π / 2 ) .$$

In the above method according to the present embodiment, the method further includes: obtaining a grid-side voltage, a d-axis component and a q-axis component of the output current of the inverter, and an α-axis component and a β-axis component of the output voltage for the inverter; determining an oscillator phase angle based on the α-axis component and the β-axis component of the target voltage instruction for the inverter; determining a current inner-loop control instruction based on the grid-side voltage and the target voltage instruction for the inverter; performing amplitude limiting processing on the current inner-loop control instruction based on a current clamping threshold to obtain a target current inner-loop control instruction; determining a d-axis component and a q-axis component of an output voltage of the inverter based on the target current inner-loop control instruction, the oscillator phase angle, and a d-axis component and a q-axis component of the grid-side voltage; generating a pulse width modulation signal based on the d-axis component and the q-axis component of the output voltage of the inverter and the oscillator phase angle; and transmitting the pulse width modulation signal to the inverter, to enable the inverter to output a second target voltage signal based on the pulse width modulation signal.

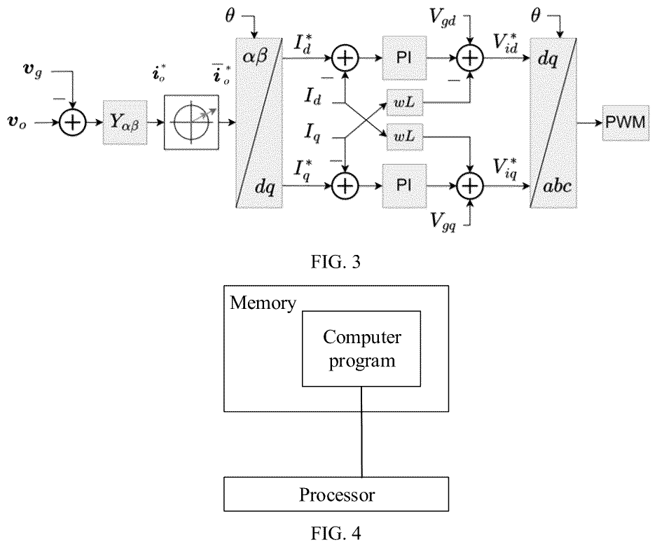

Specifically, as illustrated in the current inner-loop control block diagram in FIG. 3,

$${I}_{d}^{*} and {I}_{q}^{*}$$

represent a α-axis component and a q-axis component of a target current inner-loop control instruction, respectively. I_{d} and I_{q} represent a d-axis component and a q-axis component of a current of an inverter, respectively. ωL is a feedforward control gain, and

$${V}_{id}^{*} and {V}_{iq}^{*}$$

are the d-axis component and the q-axis component of the output voltage of the inverter, respectively. A formula for calculating the oscillator phase angle is:

$$θ = {tan}^{- 1} ( {υ}_{o β} / {υ}_{o α} ) ,$$

where θ is the oscillator phase angle, and υ_{oα} and υ_{oβ} are an α-axis component and a β-axis component of the target voltage instruction for the inverter, respectively.

A formula for calculating the current inner-loop control instruction is:

$${i}_{o}^{*} = {Y}_{αβ} \cdot ( {υ}_{o} - {υ}_{g} ) ,$$

where [symbol] is the current inner-loop control instruction, Y_{oβ} is a virtual admittance, and υ_{g}=[V_{gα} V_{gβ}] is the grid-side voltage.

A formula for calculating the target current inner-loop control instruction is:

$${\overline{i}}_{o}^{*} = \{ \begin{matrix}{i}_{o}^{*} & ‖ {i}_{o}^{*} ‖ ⩽ {I}_{max} \\ \frac{{I}_{max}}{‖ {i}_{o}^{*} ‖} {i}_{o}^{*} & ‖ {i}_{o}^{*} ‖ > {I}_{max}\end{matrix} ,$$

where Iₘₐₓ is the current clamping threshold, and ιₒ* is the target current inner-loop control instruction.

In the above method according to the present embodiment, the generating the pulse width modulation signal based on the d-axis component and the q-axis component of the output voltage of the inverter and the oscillator phase angle includes: determining a d-axis current error based on the d-axis component of the target current inner-loop control instruction and the d-axis component of the output current of the inverter, and determining the d-axis component of the output voltage of the inverter based on the determined d-axis current error, the d-axis component of the grid-side voltage, the feedforward control gain, and the q-axis component of the output current of the inverter; determining a q-axis current error based on the q-axis component of the target current inner-loop control instruction and the q-axis component of the output current of the inverter, and determining the q-axis component of the output voltage of the inverter based on the determined q-axis current error, the q-axis component of the grid-side voltage, the feedforward control gain, and the d-axis component of the output current of the inverter; and performing coordinate transformation on the d-axis component and the q-axis component of the output voltage of the inverter using the oscillator phase angle to generate the pulse width modulation signal.

In the above method according to the present embodiment, an expression of the coordinate transformation is:

$$[ \begin{matrix}{x}_{α} \\ {x}_{β}\end{matrix} ] = \sqrt{\frac{2}{3}} [ \begin{matrix}1 & - \frac{1}{2} & - \frac{1}{2} \\ 0 & \frac{\sqrt{3}}{2} & - \frac{\sqrt{3}}{2}\end{matrix} ] [ \begin{matrix}{x}_{a} \\ {x}_{b} \\ {x}_{c}\end{matrix} ] ,$$

$$[ \begin{matrix}{x}_{d} \\ {x}_{q}\end{matrix} ] = [ \begin{matrix}cos ( θ ) & sin ( θ ) \\ - sin ( θ ) & cos ( θ )\end{matrix} ] [ \begin{matrix}{x}_{α} \\ {x}_{β}\end{matrix} ] ,$$

where x denotes a voltage variable or a current variable, subscripts α, β, d, and q represent an α-axis component, a β-axis component, a d-axis component, and a q-axis component of the denoted variable, respectively.

The above-mentioned sequence can be modified by those skilled in the art without departing from the scope of the present disclosure.

Another embodiment of the present disclosure provides a full-state virtual oscillator grid-forming control apparatus. The apparatus includes: a power self-adaptive module configured to obtain a present voltage instruction for an inverter, an output current of a direct current source, an output voltage of the direct current source, and an output power of the direct current source, and determine a target active power based on the output power of the direct current source, a power operation set value, and the output voltage of the direct current source; a full-state oscillation module configured to determine an oscillation phase, an oscillation amplitude, and an oscillation frequency of the target voltage instruction for the inverter by using a full-state virtual oscillator based on the present voltage instruction for the inverter, a present output current of the inverter, the target active power, the direct current voltage amplitude set value, the alternating current voltage amplitude set value, and the rated frequency of the power grid, to generate the target voltage instruction for the inverter; and a control module configured to send the target voltage instruction for the inverter to the inverter, to enable the inverter to output a first target voltage signal based on the target voltage instruction for the inverter.

For the system in the above-described embodiments, a specific manner in which each module performs operations is already described in detail in the embodiments related to the method, and will not be elaborated upon herein.

Based on a same invention concept, the embodiments of the present disclosure further provide an electronic device. As illustrated in FIG. 4, the electronic device includes: a memory; a processor; and a computer program stored in the memory and executable on the processor. The processor is configured to, when executing the computer program, implement the photovoltaic-storage self-adaptive virtual oscillator grid-forming control method compatible with maximum power point tracking according to the above.

Based on a same invention concept, the embodiments of the present disclosure further provide a computer storage medium having a computer-executable instruction stored therein. The computer storage medium is configured to, when the computer-executable instruction is executed, implement the photovoltaic-storage self-adaptive virtual oscillator grid-forming control method compatible with maximum power point tracking according to the above.

Any modifications, additions, or equivalent substitutions made within the principles of the present disclosure shall still fall within the protection scope of the present disclosure as defined by the claims.

The term “connected” as used above, unless specifically stated otherwise, indicates a logical relationship for current transmission, and does not necessarily mean direct electrical connection. Meanwhile, terms such as “first” and “second” are not intended to indicate any sequential order, but are merely used to identify corresponding components, apparatuses, etc.

The above-mentioned voltage levels are not limited in the present disclosure and merely voltage levels provided in the embodiments.

What is claimed is:

1. A photovoltaic-storage self-adaptive virtual oscillator grid-forming control method compatible with maximum power point tracking, the method comprising:
obtaining a present voltage instruction for an inverter, an output current of a direct current source, an output voltage of the direct current source, and an output power of the direct current source, and determining a target active power based on the output power of the direct current source, a power operation set value, and the output voltage of the direct current source;
oscillating the present voltage instruction for the inverter by using a full-state virtual oscillator based on the target active power, a present output current of the inverter, and an oscillation set value to generate a target voltage instruction for the inverter; and
sending the target voltage instruction for the inverter to the inverter, to enable the inverter to output a first target voltage signal based on the target voltage instruction for the inverter.

2. The photovoltaic-storage self-adaptive virtual oscillator grid-forming control method compatible with maximum power point tracking according to claim 1, wherein said determining the target active power based on the output power of the direct current source, the power operation set value, and the output voltage of the direct current source comprises:
determining the power operation set value as the target active power when the output power of the direct current source is greater than the power operation set value; and
determining a maximum power point of the direct current source as the target active power when the output power of the direct current source is smaller than or equal to the power operation set value.

3. The photovoltaic-storage self-adaptive virtual oscillator grid-forming control method compatible with maximum power point tracking according to claim 1, wherein said determining the target active power based on the output power of the direct current source, the power operation set value, and the output voltage of the direct current source comprises:
determining the target active power by using a pre-established power self-adaptive model based on the output power of the direct current source, the power operation set value, and the output voltage of the direct current source, wherein an expression of the power self-adaptive model is:
$${p}^{*} = \{ \begin{matrix}\int {K}_{i} ( {p}_{d c} - {p}_{set} ) , & {p}_{d c} > {p}_{set} \\ \int {K}_{i} \frac{\partial {p}_{d c}}{\partial {υ}_{d c}} , & {p}_{d c} ⩽ {p}_{set}\end{matrix} ,$$
where p* is the target active power, p_{dc} is the output power of the direct current source, pₛₑₜ is the power operation set value, υ_{dc} is the output voltage of the direct current source, an operator of ∫ is an integral operation, an operator of ∂ is a differential operation, and Kᵢ is a self-adaptive power regulation control parameter.

4. The photovoltaic-storage self-adaptive virtual oscillator grid-forming control method compatible with maximum power point tracking according to claim 1, wherein expressions of the full-state virtual oscillator are:
$$\frac{d}{d t} {υ}_{o} = {ω}_{o} J {υ}_{o} + η ( K {υ}_{o} - R ( κ ) {i}_{o} + μ ϕ ( {υ}_{m} , {υ}_{d c} ) {υ}_{o} ) ,$$
$$K = \frac{1}{{υ}_{m}^{* 2}} R ( κ ) [ \begin{matrix}{p}^{*} & {q}^{*} \\ - {q}^{*} & {p}^{*}\end{matrix} ] ,$$
$${ω}_{o} = {ω}_{n} + λ \cdot sin ( κ ) ( {υ}_{d c} - {υ}_{d c}^{*} ) ,$$
$$ϕ ( {υ}_{m} , {υ}_{d c} ) = \frac{{υ}_{m}^{*} - {υ}_{m}}{{υ}_{m}^{*}} + \frac{λ}{ημ} cos κ ( {υ}_{d c} - {υ}_{d c}^{*} ) ,$$
where η is an active synchronization control parameter, μ is an amplitude control parameter, λ is a direct current voltage control parameter, υₘ=∥υₒ∥ is an alternating current voltage amplitude,
$${p}^{*} , {q}^{*} , {υ}_{d c}^{*} , {υ}_{m}^{*}$$
are the target active power, a reactive power, a direct current voltage amplitude set value, and an alternating current voltage amplitude set value, respectively, ωₙ is a rated frequency of a power grid, [symbol] is a line impedance parameter angle, K is a power setting matrix, ωₒ is a rated frequency, φ(υₘ, υ_{dc}) is a voltage amplitude error function, and [symbol]
is defined as:
$$κ = {tan}^{- 1} ( {ω}_{n} {L}_{g} / {R}_{g} )$$
where L_{g} is a grid-connected line inductance, R_{g} is a grid-connected line resistance; a matrix of R is a two-dimensional rotation matrix, which is defined as:
$$R ( θ ) = [ \begin{matrix}cos θ & - sin θ \\ sin θ & cos θ\end{matrix} ] ,$$
where θ is a matrix rotation angle;
J is defined as:
$$J = R ( π / 2 ) .$$

5. The photovoltaic-storage self-adaptive virtual oscillator grid-forming control method compatible with maximum power point tracking according to claim 1, the method further comprising:
obtaining a grid-side voltage, a d-axis component and a q-axis component of the output current of the inverter, and an α-axis component and a β-axis component of the output voltage for the inverter;
determining an oscillator phase angle based on the α-axis component and the β-axis component of the target voltage instruction for the inverter;
determining a current inner-loop control instruction based on the grid-side voltage and the target voltage instruction for the inverter;
performing amplitude limiting processing on the current inner-loop control instruction based on a current clamping threshold to obtain a target current inner-loop control instruction;
determining a d-axis component and a q-axis component of an output voltage of the inverter based on the target current inner-loop control instruction, the oscillator phase angle, and a d-axis component and a q-axis component of the grid-side voltage;
generating a pulse width modulation signal based on the d-axis component and the q-axis component of the output voltage of the inverter and the oscillator phase angle; and
transmitting the pulse width modulation signal to the inverter, to enable the inverter to output a second target voltage signal based on the pulse width modulation signal.

6. The photovoltaic-storage self-adaptive virtual oscillation grid-forming control method compatible with maximum power point tracking according to claim 5, wherein said generating the pulse width modulation signal based on the d-axis component and the q-axis component of the output voltage of the inverter and the oscillator phase angle comprises:
determining a d-axis current error based on a d-axis component of the target current inner-loop control instruction and the d-axis component of the output current of the inverter, and determining the d-axis component of the output voltage of the inverter based on the determined d-axis current error, the d-axis component of the grid-side voltage, a feedforward control gain, and the q-axis component of the output current of the inverter;
determining a q-axis current error based on a q-axis component of the target current inner-loop control instruction and the q-axis component of the output current of the inverter, and determining the q-axis component of the output voltage of the inverter based on the determined q-axis current error, the q-axis component of the grid-side voltage, the feedforward control gain, and the d-axis component of the output current of the inverter; and
performing coordinate transformation on the d-axis component and the q-axis component of the output voltage of the inverter using the oscillator phase angle to generate the pulse width modulation signal.

7. The photovoltaic-storage self-adaptive virtual oscillator grid-forming control method compatible with maximum power point tracking according to claim 6, wherein an expression of the coordinate transformation is:
$$[ \begin{matrix}{x}_{α} \\ {x}_{β}\end{matrix} ] = \sqrt{\frac{2}{3}} [ \begin{matrix}1 & - \frac{1}{2} & - \frac{1}{2} \\ 0 & \frac{\sqrt{3}}{2} & - \frac{\sqrt{3}}{2}\end{matrix} ] [ \begin{matrix}{x}_{a} \\ {x}_{b} \\ {x}_{c}\end{matrix} ] ,$$
$$[ \begin{matrix}{x}_{d} \\ {x}_{q}\end{matrix} ] = [ \begin{matrix}cos ( θ ) & sin ( θ ) \\ - sin ( θ ) & cos ( θ )\end{matrix} ] [ \begin{matrix}{x}_{α} \\ {x}_{β}\end{matrix} ] ,$$
where x denotes a voltage variable or a current variable, subscripts α, β, d, and q represent an α-axis component, a β-axis component, a d-axis component, and a q-axis component of the denoted variable, respectively, and θ is the oscillator phase angle.

8. An electronic device, comprising:
a memory;
a processor; and
a computer program stored in the memory and executable on the processor, wherein the processor is configured to, when executing the computer program, implement a photovoltaic-storage self-adaptive virtual oscillator grid-forming control method compatible with maximum power point tracking, the method comprising:
obtaining a present voltage instruction for an inverter, an output current of a direct current source, an output voltage of the direct current source, and an output power of the direct current source, and determining a target active power based on the output power of the direct current source, a power operation set value, and the output voltage of the direct current source;
oscillating the present voltage instruction for the inverter by using a full-state virtual oscillator based on the target active power, a present output current of the inverter, and an oscillation set value to generate a target voltage instruction for the inverter; and
sending the target voltage instruction for the inverter to the inverter, to enable the inverter to output a first target voltage signal based on the target voltage instruction for the inverter.

9. The electronic device according to claim 8, wherein said determining the target active power based on the output power of the direct current source, the power operation set value, and the output voltage of the direct current source comprises:
determining the power operation set value as the target active power when the output power of the direct current source is greater than the power operation set value; and
determining a maximum power point of the direct current source as the target active power when the output power of the direct current source is smaller than or equal to the power operation set value.

10. The electronic device according to claim 8, wherein said determining the target active power based on the output power of the direct current source, the power operation set value, and the output voltage of the direct current source comprises:
determining the target active power by using a pre-established power self-adaptive model based on the output power of the direct current source, the power operation set value, and the output voltage of the direct current source, wherein an expression of the power self-adaptive model is:
$${p}^{*} = \{ \begin{matrix}\int {K}_{i} ( {p}_{dc} - {p}_{set} ) , & {p}_{dc} > {p}_{set} \\ \int {K}_{i} \frac{\partial {p}_{dc}}{\partial {v}_{dc}} , & {p}_{dc} ⩽ {p}_{set}\end{matrix} ,$$
where p* is the target active power, p_{dc} is the output power of the direct current source, pₛₑₜ is the power operation set value, υ_{dc} is the output voltage of the direct current source, an operator of ∫ is an integral operation, an operator of ∂ is a differential operation, and Kᵢ is a self-adaptive power regulation control parameter.

11. The electronic device according to claim 8, wherein expressions of the full-state virtual oscillator are:
$$\frac{d}{d t} {v}_{o} = {ω}_{o} {Jv}_{o} + η ( {Kv}_{o} - R ( κ ) {i}_{o} + μϕ ( {v}_{m} , {v}_{dc} ) {v}_{o} ) ,$$
$$K = \frac{1}{{v}_{m}^{* 2}} R ( κ ) [ \begin{matrix}{p}^{*} & {q}^{*} \\ - {q}^{*} & {p}^{*}\end{matrix} ] ,$$
$${ω}_{o} = {ω}_{n} + λ \cdot sin ( κ ) ( {v}_{dc} - {v}_{dc}^{*} ) ,$$
$$ϕ ( {v}_{m} , {v}_{dc} ) = \frac{{v}_{m}^{*} - {v}_{m}}{{v}_{m}^{*}} + \frac{λ}{η μ} cos κ ( {v}_{dc} - {v}_{dc}^{*} ) ,$$
where η is an active synchronization control parameter, μ is an amplitude control parameter, λ is a direct current voltage control parameter, υₘ=∥υₒ∥ is an alternating current voltage amplitude,
$${p}^{*} , {q}^{*} , {v}_{dc}^{*} , {v}_{m}^{*}$$
are the target active power, a reactive power, a direct current voltage amplitude set value, and an alternating current voltage amplitude set value, respectively, ωₙ is a rated frequency of a power grid, [symbol] is a line impedance parameter angle, K is a power setting matrix, ωₒ is a rated frequency, φ(υₘ, υ_{dc}) is a voltage amplitude error function, and [symbol]
is defined as:
$$κ = {tan}^{- 1} ( {ω}_{n} {L}_{g} / {R}_{g} )$$
where L_{g} is a grid-connected line inductance, R_{g} is a grid-connected line resistance; a matrix of R is a two-dimensional rotation matrix, which is defined as:
$$R ( θ ) = [ \begin{matrix}cos θ & - sin θ \\ sin θ & cos θ\end{matrix} ] ,$$
where θ is a matrix rotation angle;
J is defined as:
$$J = R ( π / 2 ) .$$

12. The electronic device according to claim 8, wherein the method further comprises:
obtaining a grid-side voltage, a d-axis component and a q-axis component of the output current of the inverter, and an α-axis component and a β-axis component of the target voltage instruction for the inverter;
determining an oscillator phase angle based on the α-axis component and the β-axis component of the target voltage instruction for the inverter;
determining a current inner-loop control instruction based on the grid-side voltage and the target voltage instruction for the inverter;
performing amplitude limiting processing on the current inner-loop control instruction based on a current clamping threshold to obtain a target current inner-loop control instruction;
determining a d-axis component and a q-axis component of an output voltage of the inverter based on the target current inner-loop control instruction, the oscillator phase angle, and a d-axis component and a q-axis component of the grid-side voltage;
generating a pulse width modulation signal based on the d-axis component and the q-axis component of the output voltage of the inverter and the oscillator phase angle; and
transmitting the pulse width modulation signal to the inverter, to enable the inverter to output a second target voltage signal based on the pulse width modulation signal.

13. The electronic device according to claim 12, wherein said generating the pulse width modulation signal based on the d-axis component and the q-axis component of the output voltage of the inverter and the oscillator phase angle comprises:
determining a d-axis current error based on a d-axis component of the target current inner-loop control instruction and the d-axis component of the output current of the inverter, and determining the d-axis component of the output voltage of the inverter based on the determined d-axis current error, the d-axis component of the grid-side voltage, a feedforward control gain, and the q-axis component of the output current of the inverter;
determining a q-axis current error based on a q-axis component of the target current inner-loop control instruction and the q-axis component of the output current of the inverter, and determining the q-axis component of the output voltage of the inverter based on the determined q-axis current error, the q-axis component of the grid-side voltage, the feedforward control gain, and the d-axis component of the output current of the inverter; and
performing coordinate transformation on the d-axis component and the q-axis component of the output voltage of the inverter using the oscillator phase angle to generate the pulse width modulation signal.

14. The electronic device according to claim 13, wherein an expression of the coordinate transformation is:
$$[ \begin{matrix}{x}_{α} \\ {x}_{β}\end{matrix} ] = \sqrt{\frac{2}{3}} [ \begin{matrix}1 & - \frac{1}{2} & - \frac{1}{2} \\ 0 & \frac{\sqrt{3}}{2} & - \frac{\sqrt{3}}{2}\end{matrix} ] [ \begin{matrix}{x}_{a} \\ {x}_{b} \\ {x}_{c}\end{matrix} ] ,$$
$$[ \begin{matrix}{x}_{d} \\ {x}_{q}\end{matrix} ] = [ \begin{matrix}cos ( θ ) & sin ( θ ) \\ - sin ( θ ) & cos ( θ )\end{matrix} ] [ \begin{matrix}{x}_{α} \\ {x}_{β}\end{matrix} ] ,$$
where x denotes a voltage variable or a current variable, subscripts α, β, d, and q represent an α-axis component, a β-axis component, a d-axis component, and a q-axis component of the denoted variable, respectively, and θ is the oscillator phase angle.

15. A non-transitory computer storage medium having a computer-executable instruction stored therein, wherein the computer storage medium is configured to, when the computer-executable instruction is executed, implement a photovoltaic-storage self-adaptive virtual oscillator grid-forming control method compatible with maximum power point tracking, the method comprising:
obtaining a present voltage instruction for an inverter, an output current of a direct current source, an output voltage of the direct current source, and an output power of the direct current source, and determining a target active power based on the output power of the direct current source, a power operation set value, and the output voltage of the direct current source;
oscillating the present voltage instruction for the inverter by using a full-state virtual oscillator based on the target active power, a present output current of the inverter, and an oscillation set value to generate a target voltage instruction for the inverter; and
sending the target voltage instruction for the inverter to the inverter, to enable the inverter to output a first target voltage signal based on the target voltage instruction for the inverter.

16. The non-transitory computer storage medium according to claim 15, wherein said determining the target active power based on the output power of the direct current source, the power operation set value, and the output voltage of the direct current source comprises:
determining the power operation set value as the target active power when the output power of the direct current source is greater than the power operation set value; and
determining a maximum power point of the direct current source as the target active power when the output power of the direct current source is smaller than or equal to the power operation set value.

17. The non-transitory computer storage medium according to claim 15, wherein said determining the target active power based on the output power of the direct current source, the power operation set value, and the output voltage of the direct current source comprises:
determining the target active power by using a pre-established power self-adaptive model based on the output power of the direct current source, the power operation set value, and the output voltage of the direct current source, wherein an expression of the power self-adaptive model is:
$${p}^{*} = \{ \begin{matrix}\int {K}_{i} ( {p}_{dc} - {p}_{set} ) , & {p}_{dc} > {p}_{set} \\ \int {K}_{i} \frac{\partial {p}_{dc}}{\partial {v}_{dc}} , & {p}_{dc} ⩽ {p}_{set}\end{matrix} ,$$
where p* is the target active power, p_{dc} is the output power of the direct current source, pₛₑₜ is the power operation set value, υ_{dc} is the output voltage of the direct current source, an operator of ∫ is an integral operation, an operator of ∂ is a differential operation, and Kᵢ is a self-adaptive power regulation control parameter.

18. The non-transitory computer storage medium according to claim 15, wherein expressions of the full-state virtual oscillator are:
$$\frac{d}{d t} {v}_{o} = {ω}_{o} {Jv}_{o} + η ( {Kv}_{o} - R ( κ ) {i}_{o} + μϕ ( {v}_{m} , {v}_{dc} ) {v}_{o} ) ,$$
$$K = \frac{1}{{v}_{m}^{* 2}} R ( κ ) [ \begin{matrix}{p}^{*} & {q}^{*} \\ - {q}^{*} & {p}^{*}\end{matrix} ] ,$$
$${ω}_{o} = {ω}_{n} + λ \cdot sin ( κ ) ( {v}_{dc} - {v}_{dc}^{*} ) ,$$
$$ϕ ( {v}_{m} , {v}_{dc} ) = \frac{{v}_{m}^{*} - {v}_{m}}{{v}_{m}^{*}} + \frac{λ}{η μ} cos κ ( {v}_{dc} - {v}_{dc}^{*} ) ,$$
where η is an active synchronization control parameter, μ is an amplitude control parameter, λ is a direct current voltage control parameter, υₘ=∥υₒ∥ is an alternating current voltage amplitude,
$${p}^{*} , {q}^{*} , {v}_{dc}^{*} , {v}_{m}^{*}$$
are the target active power, a reactive power, a direct current voltage amplitude set value, and an alternating current voltage amplitude set value, respectively, ωₙ is a rated frequency of a power grid, [symbol] is a line impedance parameter angle, K is a power setting matrix, ωₒ is a rated frequency, φ(υₘ, υ_{dc}) is a voltage amplitude error function, and [symbol]
is defined as:
$$κ = {tan}^{- 1} ( {ω}_{n} {L}_{g} / {R}_{g} )$$
where L_{g} is a grid-connected line inductance, R_{g} is a grid-connected line resistance; a matrix of R is a two-dimensional rotation matrix, which is defined as:
$$R ( θ ) = [ \begin{matrix}cos θ & - sin θ \\ sin θ & cos θ\end{matrix} ] ,$$
where θ is a matrix rotation angle;
J is defined as:
$$J = R ( π / 2 ) .$$

19. The non-transitory computer storage medium according to claim 15, wherein the method further comprises:
obtaining a grid-side voltage, a d-axis component and a q-axis component of the output current of the inverter, and an α-axis component and a β-axis component of the output voltage for the inverter;
determining an oscillator phase angle based on the α-axis component and the β-axis component of the target voltage instruction for the inverter;
determining a current inner-loop control instruction based on the grid-side voltage and the target voltage instruction for the inverter;
performing amplitude limiting processing on the current inner-loop control instruction based on a current clamping threshold to obtain a target current inner-loop control instruction;
determining a d-axis component and a q-axis component of an output voltage of the inverter based on the target current inner-loop control instruction, the oscillator phase angle, and a d-axis component and a q-axis component of the grid-side voltage;
generating a pulse width modulation signal based on the d-axis component and the q-axis component of the output voltage of the inverter and the oscillator phase angle; and
transmitting the pulse width modulation signal to the inverter, to enable the inverter to output a second target voltage signal based on the pulse width modulation signal.

20. The non-transitory computer storage medium according to claim 19, wherein said generating the pulse width modulation signal based on the d-axis component and the q-axis component of the output voltage of the inverter and the oscillator phase angle comprises:
determining a d-axis current error based on a d-axis component of the target current inner-loop control instruction and the d-axis component of the output current of the inverter, and determining the d-axis component of the output voltage of the inverter based on the determined d-axis current error, the d-axis component of the grid-side voltage, a feedforward control gain, and the q-axis component of the output current of the inverter;
determining a q-axis current error based on a q-axis component of the target current inner-loop control instruction and the q-axis component of the output current of the inverter, and determining the q-axis component of the output voltage of the inverter based on the determined q-axis current error, the q-axis component of the grid-side voltage, the feedforward control gain, and the d-axis component of the output current of the inverter; and
performing coordinate transformation on the d-axis component and the q-axis component of the output voltage of the inverter using the oscillator phase angle to generate the pulse width modulation signal.
